(19) United States
(12) Patent Application Publication
(10) Pub. No.: US 2014/0336830 A1
(43) Pub. Date: Nov. 13, 2014

(54) OPTIMISING USE OF ENERGY

(71) Applicant: Andrew Williams, Buckinghamshire (GB)

(72) Inventor: Andrew Williams, Buckinghamshire (GB)

(73) Assignee: BUILDING RESEARCH ESTABLISHMENT LTD, Hertfordshire (GB)

(21) Appl. No.: 14/117,517

(22) PCT Filed: May 11, 2012
(86) PCT No.: PCT/GB12/51063

§ 371 Date: Jul. 29, 2014

(30) Foreign Application Priority Data
May 13, 2011 (GB) 1108050.4

(51) Int. Cl. G05B 13/02

(52) U.S. Cl. CPC G05B 13/02
USPC 700/286

(57) ABSTRACT

Electrical apparatus comprising an electrical device provided with, or having associated therewith, an energy usage profile.

This invention relates to optimising use of energy. In particular, it relates to systems, methods and devices adapted to optimise energy usage, in particular to optimise the use of sustainable energy.

Great efforts are being applied to increase the use of sustainable energy. These include encouraging consumers to buy sustainable energy from the national supply grid. and to install their own local sustainable energy generators, such as photovoltaic (PV) cell technology, wind turbine and so on which can be used to generate power to supplement a mains supply and/or which can be sold back to the national grid.

The present invention arose in an attempt to provide a method by which devices in a network may, by virtue of their inherent properties and capabilities, be able to influence optimising of energy usage, or use of a particular type of energy within the network.

Note that in this specification, the term ‘device’ is intended to be construed broadly and to include any electrical items commonly used in a household, workplace, residential environment or other environments, for example, but not limited to, computer equipment; audio, visual or entertainment equipment; so-called white goods such as refrigerators, washing machines and so; cookers, heating, cooling and ventilation apparatus, and many other types of electrically powered, or electrically controlled, devices. It may also include electric vehicles.

According to the present invention in a first aspect there is provided an electrical device provided with, or having associated therewith, a readable energy usage profile.

The profile may be adapted to be read and/or downloaded by external apparatus. Alternatively or in additional, it may be written to the device by external apparatus. The profile may preferably be electronically stored, for example as digital data or other data in a database or memory provided on the device or elsewhere and used to determine how that device uses energy.

Instead of, or as well as, being stored or readable from the device it may be stored on or otherwise readable from an external device connected or connectable to the device.

The data may comprise one or more different items of data. For example, it may include the device's ability to store power, the amount of power used by the device, the standby power consumed by the device, preferred time of use, a history of times of use or other history related to use, distributed power potential from storage (ie ability of the device to export power from internal storage), the time taken for any in-built power storage (such as rechargeable batteries) to discharge or to charge, actual capacity, minimum capacity, power potential, performance parameters, tolerances and many other types of data.

The profile (which may be termed a ‘carbon’ or ‘green’ profile or a device's ‘DNA’) may be used by other equipment connected to a common mains system or network in order to control and/or organise power allocated to the device, or may be used by the device itself, or other equipment connected to the device and/or power supply or network to determine and manage use of the device within a control network or system and/or in relation to a number of devices. Use may be managed within overall system building performance requirements or abilities. This may be, for example, to correspond with device and/or network control parameters or other requirements.

By providing an electronic carbon profile as described, individual devices in an environment can be arranged to optimise energy consumption across a range of devices on a network. For example, to maximise use of sustainable power.

In some embodiments, the energy profile of each device is arranged to be read by a control means provided on a power supply or data network connected to the device. The central control means be arranged to manage use of the device in accordance with parameters of the profile.

The profile may be a look-up table, or otherwise, and may enable a computer or other device to be able to ‘see’ energy options available to it for that device. The ‘energy’ options may relate to ‘sustainability’ or ‘carbon’-based parameters and allow a controlling device to optimally operate and/or control or influence power use of the device and/or of a network including the devices.

A remote device may be provided, which might be in the form of a plug, for plugging into a mains power supply or other power supply, or be adapted to plug into a data network, the plug being connected by wires or wirelessly to the device and/or to a network control unit or other control apparatus.

The remote device may be a plug which has an electrical connection to the device for enabling the device to be plugged into and receive power from a power supply or may be a different device.

The remote device may have means for receiving or interfacing with the profile data on the device. Alternatively, or in addition, it may store the profile data for one or more associated devices itself. In this case, the or each associated device need not locally store the profile data.

The remote device may be arranged to read data from a device when connected, by wires or wirelessly, to it and may be adapted to set a particular energy use protocol or profile for determining energy used from the power supply for that device according to the device's profile. The remote device may be adapted to send the profile, or part of it, to a central control unit or to use the data purely locally.

Embodiments of the invention will now be described, by way of example only, with reference to the accompanying drawings, in which:

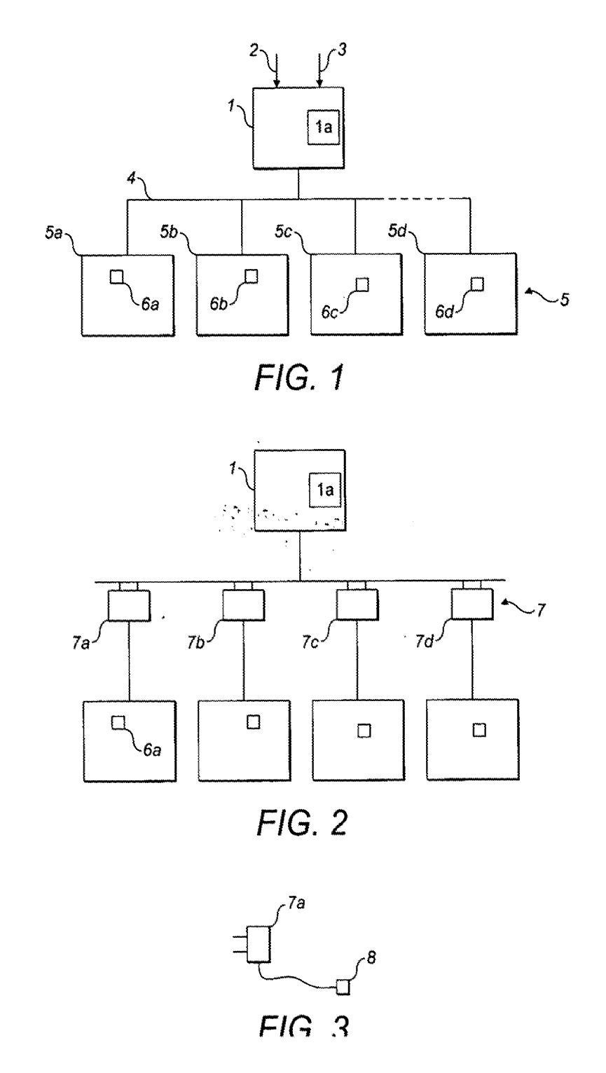

FIG. 1 shows a number of electrical devices connected to a power supply;

FIG. 2 shows an alternative arrangement; and

FIG. 3 shows a ‘smart plug’ arrangement.

Referring to FIG. 1, there is shown, very schematically, an arrangement of electrical devices in a premises. The premises includes a power supply 1 which may be fed, for example, by both a mains supply 2 and a photovoltaic (PV) supply 3 or other sustainable supply. Alternatively, there may be just one supply or more than two. This may, for example, be a PV inverter. This supplies power over a power line 4 of any convenient type, such as a ring main in a household environment. It will typically be AC power, although in other embodiments, the power may be supplied as DC power, perhaps over a Power over Ethernet (PoE) network, or other network.

A plurality of devices 5a, 5b, . . . 5n are connected to the power line 4. These may be any types of devices ranging from small portable electronic media devices, goods such as cooking, ventilation, heating and washing/drying devices, computer equipment, TV, DVD or other audio-visual apparatus or any other electrical items.

At least one of the devices connected to the network is provided with an energy use profile which is electronically stored either on or associated with the device or on an electronically or otherwise digitally accessible tag or other device. This may be stored in an onboard memory on the device, on a tag associated with it, or otherwise associated with. This may be in the form of read-only memory (ROM) so that once established for a device these parameters cannot be changed, or may be variable, for example stored in random access memory (RAM) or otherwise, if the parameters of a device can change with time, use or otherwise.

The energy usage profile may comprise any one or more items of data including, for example, but not limited to, power used in operation, time of normal use or other data related to time of use, time and the day; amount of standby power required when the device is in a standby mode; standby control options; storage capacity; distributed power potential from storage (ie ability of the device to export energy, from its stored capacity, to the network), actual capacity, minimum capacity, power potential; and; how long the device can last on fully and/or partially charged batteries or other energy storage means. Data can relate to expected use at different times of use during the day, week, month, year, season or other periods. For example, heating equipment will be used much more in winter than summer.

The data may consist of a combination of parameters relating to a device, for example:
performance parameters (essentially the device's output performance—the reason its there and its delivery performance/criteria)
controllability (essentially the device's input performance—the scope for controlling/reading the device as part of a network)
Inherent capacity (essentially the device's internal performance and capability to support the use of sustainable energy/network for example export energy from an internal store such as a battery).

It may also include details of the priority that device could have for using power. This may be a preset priority level or determined with reference to other devices on the same power supply or data network. For example, in a household environment it might be a top priority that an oven or cooker maintain power as much as possible, or that heating equipment be given top priority, particularly in the winter, whereas an audio device or an aesthetic light device might be given a much lower priority. This enables, in a network and, in the case of a limited amount of power, for the possibility of diverting power resources to the highest priority devices to keep those running as much as possible at the expense of lower or zero running of devices of lower priority.

The power or energy used profile may be stored in the memory 6a, 6b, . . . 6n or other device on or associated with each or one or more of the power using devices 5a to 5n.

In some embodiments, the device is arranged so that it can be interrogated by, download to, or otherwise interact with, a control unit 1a provided at the central power supply 1. Thus, details are provided of the or each device and its energy profile where this is provided. The control until 1 can then manage power effectively on the network and, if it is also provided with means for knowing the ‘sustainable’ level or proportion of power which it receives at any time, it can use this, in combination with the energy profile (so-called green-profile) to maximise use of sustainable energy when this is available and to minimise use of energy when less or no sustainable energy is available. Many ways of using the energy and of using the profiles will be apparent.

FIG. 2 shows a modification in which one or more devices, having an energy profile as described above, is or are connected to a power supply network 4 by a plug-in device 7a, 7b, . . . 7n. This might be an electrical plug (eg a three-pin type as used in the UK, a round two-pin type as used in Europe or a flat two-pin type as used in USA, for example). This can be provided with intelligence ie a memory (eg a processor) or other means so that the green profile 6a of a particular device can either be downloaded to the plug element 7, read by it or otherwise be enabled to interact with it.

Alternatively, or in addition, the plug may itself be provided (programmed or otherwise) with a profile relating to a device, or indeed with a number of profiles related to a plurality of devices.

Of course, in some embodiments some of the devices 5 may be connected directly to a power supply whilst others are connected through a ‘smart’ plug or other interface 7.

A ‘smart plug’ such as plug/device 7a has the advantage that by being able to access in some way the green profile on one or more associated devices, the smart plug can be arranged to influence the power supplied from the power supply 1 (or being directly supplied with) to the device at any time, dependent upon the green profile of a device itself. At a time of day when the green device is not required to be used, the smart plug 7a may be provided with a means for blocking power from being sent to the device at all. This may be by switch, a relay operated mechanism or many other types of mechanisms. Similarly, if a device is of lower priority and the power supply is at a low level, or has signalled to the smart plug 7a that the power supply at a particular time does not include a very high ratio of sustainable energy, then it may also not allow power to be used by the device. If a device is of high priority then it will allow power to be used by the device at more times or all the time.

The smart plug 7a or indeed the device itself, may also be provided with means for using the device's ‘green’ profile (energy use profile) to only enable the device to use power for a sufficient length of time to charge a battery or other power storage means or to only use enough power to trickle charge or to keep the device running at a low level such as a standby level or other level.

The devices can be arranged to communicate or interact with one another either directly or via a network and/or with smart plugs arranged to interact with each other and/or selected devices so that power usage and use of the energy use profile can be determined in a distributed manner taking the requirements, capabilities and profiles of a plurality of devices on a network into account.

A smart plug may be able to use the power of its associated device itself, or may be arranged, when connected to the device and to a power supply, to send the profile, or selected data taken from it, to a central control unit 1a. It may be arranged to read or download the data as soon as it is connected to the device, it may be arranged to set a particular command protocol for energy use when it receives this data, or to dynamically vary energy use with time of day or otherwise.

FIG. 3 shows how a smart plug 7a may be connected to a device by means of a standard interface such as a USB type connector 8 in which case each device 5 will be provided with a suitable USB connector. Other connection means may of course be used and the connection may be by wire or wireless. The smart plug 7a need not necessarily be one which connects to a power supply in order to supply power to the device; it can simply be a connector for connection to a data network and the device may derive its power from that network or from a separate power supply system.

The device's profile may be able to be written to the device from external apparatus, which term includes programming a memory or other data store on the device with the profile. The profile may change over time, or with different usage or environmental requirements, so may need adapting in which case being able to write to the device so it can be altered as desired.

1. Electrical apparatus comprising an electrical device provided with, or having associated therewith, a readable energy usage profile.

2. Apparatus as claimed in claim 1, wherein the energy usage profile comprises data readable from said electrical device or on a further electrical device adapted to connect with said first device.

3. Apparatus as claimed in claim 1, wherein the energy usage profile is writable to the electrical device or a further electrical device adapted to connect with said first device.

4. Apparatus as claimed in claim 2, wherein the profile is a set of stored data.

5. Apparatus as claimed in claim 2, wherein said data is adapted to be read/write and/or downloaded by further apparatus and to provide an indication to said further apparatus of the energy usage profile.

6. Apparatus as claimed in claim 1, wherein the energy usage profile comprises one or more items of data including any one or more of the following: the device's ability to store power, the amount of power used by the device, the standby power consumed by the device, preferred time of use, a history of times of use or other history related to use, ability of the device to export power from internal storage, the time taken for any in-built power storage to discharge or to charge, actual capacity, minimum capacity, and; power potential.

7. A network comprising an electrical device, an energy usage profile associated with such device, means for supplying power to said device and means for using the profile to control and/or organise power allocated to the device to determine and manage use of the device within a network.

8. A network as claimed in claim 7, wherein the usage profile is usable by other equipment on the network in order to control and/or organise power allocated to the device, or usable by a device itself, or other equipment connected to the device and/or power supply to determine and/or manage use of the device.

9. A network as claimed in claim 7, comprising a plurality of devices having energy usage profiles and means for managing power supply to the plurality of device to optimise energy consumption across the devices within the network.

10. A network as claimed in claim 9, wherein at least a proportion of power input to the system is from a sustainable source and the energy usage profile being used, at least in part, to optimise use of sustainable power.

11. Apparatus as claimed in claim 2, wherein a remote device is connected to an electrical device, the remote device including, or having means for receiving the profile data from the device in order to set a particular energy use protocol or profile for determining energy use from the power supply for that used from a power supply for that device.

12. Apparatus as claimed in claim 11, wherein the remote device is a plug adapted to connect to a device having a power profile.

13. Apparatus as claimed in claim 11, wherein the remote device contains one or more energy usage profiles corresponding, respectively, to one or more electrical devices and is used as an interface between that device and a power control means in order to set a particular energy use from a power supply for that device.

14. Apparatus as claimed in claim 11, wherein the remote device is adapted to transmit the profile, or part of it, to a central control unit.

15. Apparatus as claimed in claim 11, wherein the remote device is adapted to use the profile of the or each connected device which has a profile locally.

16. Apparatus as claimed in claim 1, wherein the device having a profile, or a remote device associated therewith, is adapted, upon connection to a network, to transmit the profile to a control unit.

17. A method of optimising energy usage, comprising associating with one or more electrical devices on a network and the energy usage profile, the energy usage profile of the or each device being used to optimise power used by that device and/or by a plurality of devices within a network.

18-20. (canceled)
